(19) United States
(12) Patent Application Publication
(10) Pub. No.: US 2002/0172235 A1
(43) Pub. Date: Nov. 21, 2002

(54) Producing energetic, tunable, coherent X-rays with long wavelength light

(76) Inventors: Zenghu Chang, Manhattan, KS (US); Bing Shan, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 10/139,575

(22) Filed: May 6, 2002

Related U.S. Application Data
(60) Provisional application No. 60/289,228, filed on May 7, 2001.

(51) Int. Cl. H01S 3/30

(52) U.S. Cl. 372/5

(57) ABSTRACT

An apparatus and method are provided for producing x-rays by generating high harmonic radiation with long wavelength light. The use of long wavelength light increases the acceleration time of the electrons in the light field. Keeping the atomic species and light intensity unchanged, the x-ray photon energy increases by a factor of two to four when the fundamental wavelength increases by a factor of two.

### CROSS REFERENCE TO RELATED APPLICATIONS

This application claims the benefit of U.S. Provisional Application No. 60/289,228, filed May 7, 2001.

### STATEMENT REGARDING FEDERALLY SPONSORED RESEARCH OR DEVELOPMENT

The government of the United States of America may have rights in this invention under National Science Foundation grant no. PHY8920108 and Department of Energy grant No. DE-FG02-00ER15082.

### BACKGROUND OF THE INVENTION

1. Field of the Invention

The present invention relates to coherent x-ray sources and, more particularly, to the production of energetic, coherent x-rays by interacting select gases with long wavelength light.

2. Description of Related Art

Coherent x-ray sources are very important for semiconductor, medical and biological industries. Coherent x-ray sources also have wide applications in material studies. Currently, synchrotron radiation is the dominate coherent x-ray source for these applications. Unfortunately, there are only a few synchrotrons in the United States. Furthermore, since it is extremely expensive to build and operate a synchrotron, all of the synchrotrons in the United States are in national laboratories. This severely limits the application of synchrotrons as coherent x-ray sources.

Recently, another source of coherent x-rays has gained attention. This source uses high order harmonic laser generation to produce coherent x-rays. As compared to synchrotrons, x-ray sources based on high order harmonic generation are much cheaper, much more compact and much easier to operate.

X-ray production by high harmonic generation can be understood by a three-step model. First, the bound electrons of atoms tunnel through the Coulomb barrier suppressed by a light field and then the freed electrons move in the light field. Second, when the light field reverses direction, some of the electrons move back towards their parent ions and are accelerated by the light field. Third, when the electrons meet the parent ions, a portion of the electrons recombine with the ions and emit photons. The photon energy equals the kinetic energy that the electrons acquired from the light field plus the ionization potential of the electrons in the atom. For strong light/atom interaction, the recombination emission falls in the x-ray wavelength range.

The main cost of an x-ray source based on high harmonic generation is the cost of the high intensity laser. Since the cost of the laser is strongly dependent upon its output power, it is desirable to produce x-rays with the lowest possible laser power. However, it is also desirable to extend the photon energy towards the hard x-ray range.

Prior to the present invention, the most effective high harmonic generation method employed lasers with short pulse durations. The shortest harmonics generated so far have a photon energy of about 0.5 keV, which can be used in many applications such as ultrafast fluorescent spectroscopy, biological microscopy and x-ray nonlinear optics. However, great effort is currently being invested to extend high harmonic generation into the keV x-ray regime, where further ground breaking applications would become possible. For example, the short pulse duration and high coherence of keV harmonic sources enable time resolved x-ray spectroscopy experiments on an unprecedented time scale, thereby allowing the observation of fundamental dynamical processes.

Although short laser pulses such as 5 fs have been used to produce x-rays, reducing the pulse duration increases the lasers intensity. As such, to produce an x-ray, high intensity light pulses with >100 μJ pulse energy are required. Unfortunately, the high laser intensity associated with extremely short pulses and the limitation of the photon energy to the soft x-ray range limits the effectiveness of this technique. Another problem associated with conventional high harmonic generation methods is that these methods only produce radiation in the odd multiples of the fundamental light photon energy. Accordingly, the radiation does not cover all the spectra range between the neighboring orders.

In as much as a 5 fs laser pulse is on the order of one optical cycle, this is almost the shortest pulse producible. As such, it is unlikely that high harmonic generation studies will be furthered by continuing efforts in this smaller laser pulse direction. One alternative direction previously considered involves reducing the size of the laser spot. However, this method has also been deemed unacceptable since it causes phase-matching problems. Another alternative direction involves high harmonic generation from ions or from core electrons. However, these techniques are yet to be confirmed by experiments.

In the following detailed description, a novel technique is described that dramatically extends the cut-off photon energy of given atoms and is capable of producing keV x-rays.

### SUMMARY OF THE INVENTION

It has been discovered that x-rays can be produced by generating high harmonic radiation with long wavelength light. In order to produce the most energetic x-ray, the electrons should gain as much energy as possible from the light field during one optical cycle. For a given potential field, the kinetic energy that an object acquires is proportional to the square of the time that the object travels in the field. Since one optical period is the longest time that the electrons can be accelerated in the light field, light having a long optical cycle should be used.

Since wavelength is proportional to optical period, the use of long wavelength light increases the acceleration time of the electron in the field. Keeping the atomic species and light intensity unchanged, x-ray photon energy increases by a factor of two to four when the fundamental wavelength increases by a factor of two. As such, a given photon energy x-ray can be produced at half or a quarter laser intensity by using long wavelength light as compared to conventional short wavelength light.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of an apparatus for generating an x-ray with a long wavelength source;

FIG. 2 is a schematic illustration of an analogy of electron acceleration in a light field;

FIG. 3 is a graph illustrating a comparison of calculated spectra from xenon gas interacting with 0.8 μm and 1.6 μm light;

FIG. 4 is a schematic illustration of a device for generating x-rays with long wavelength light;

FIG. 5 is a graph illustrating high harmonic generation produced by 100 μJ, 25 fs laser pulses in argon gas;

FIG. 6 is a graph illustrating the calculated relationship between single atom high harmonic generation cut-off photon energy and the driving wavelength;

FIG. 7 is a schematic illustration of an experimental device for performing high harmonic generation with a long wavelength pump;

FIG. 8 is a graph illustrating a simulation of high harmonic generation intensity by a 1.51 μm pump laser interacting with 2 μm and 200 μm argon gas; and

FIG. 9 is a graph illustrating high harmonic generation by 50 μJ, 25 fs laser pulses of different wavelengths in xenon gas.

### DETAILED DESCRIPTION OF THE PREFERRED EMBODIMENTS

The following description of the preferred embodiments is merely exemplary in nature and is in no way intended to limit the invention, its application, or uses.

The present invention is directed towards a novel method of producing coherent x-rays. The method involves interacting gases with long wavelength light pulses from an optical parametric amplifier to produce a given wavelength x-ray. Advantageously, the wavelength of the x-ray produced by this method can be tuned to match the x-ray optics in the desired final application by changing the wavelength of the light from the optical parametric amplifier.

In addition to the foregoing, the present method also has the potential to produce hard x-rays which cannot be produced with short wavelength light. Also, by using long wavelength light, the pulse energy requirement of the light reduces by a factor of 2 to 4 as compared with using conventional short wavelength light pulses. This greatly reduces the cost of the x-ray source.

As will be described in detail below, x-ray photon energy can be increased by interacting atoms with long wavelength light. In one experiment, 1.5 μm wavelength light was produced by an optical parametric amplifier. This wavelength is nearly twice the 0.8 μm wavelength light of high intensity lasers commonly used for high harmonic generation.

Using xenon as the interaction gas, high harmonics were produced with a photon energy up to ˜80 eV using the 1.5 μm light. This is much higher than the highest photon energy (45 eV) ever produced with 0.8 μm laser. Further, the intensity of the 1.5 μm light is only 1×10¹⁴ W/cm². To produce such x-rays with a 0.8 μm laser, the intensity would be twice as high. With argon gas, the highest photon energy is 160 eV with the 1.5 μm pump as compared to 64 eV with the 0.8 μm laser.

As noted above, the light from the optical parametric amplifier is tunable. As such, the wavelength of x-ray can be tuned to cover the spectra between neighboring harmonics. This is crucial for x-ray lithography in the semiconductor industry. The bandwidth of the mirrors used for lithography is narrow and there is no guarantee that the x-ray produced by a fixed wavelength laser will fall at the peak of the reflection. With the optical parametric amplifier, the x-ray can be tuned to use the x-ray mirror most effectively.

Turning now to FIG. 1, an apparatus for generating an x-ray with a long wavelength source is illustrated. The apparatus 10 includes a long wavelength light source 12 and an optical member 14 such as a lens or mirror. An area 16 is filled with gas 18 such as argon, xenon or helium. Although other wavelengths may be suitable, it is presently preferred to provide long wavelength source which produces wavelengths between about 0.8 and about 1.6 μm.

The long wavelength light source 12 produces high power light pulses in the form of a beam 20. The light beam 20 is focused by the optical member 14 (lens or mirror) to the area 16 filled with gas 18. The light intensity is such that it is high enough to ionize the gas 18. X-ray pulses 22 are produced as a result of the light/gas interaction. For a given gas and light intensity, the long wavelength light 20 produces high photon energy in the x-ray 22.

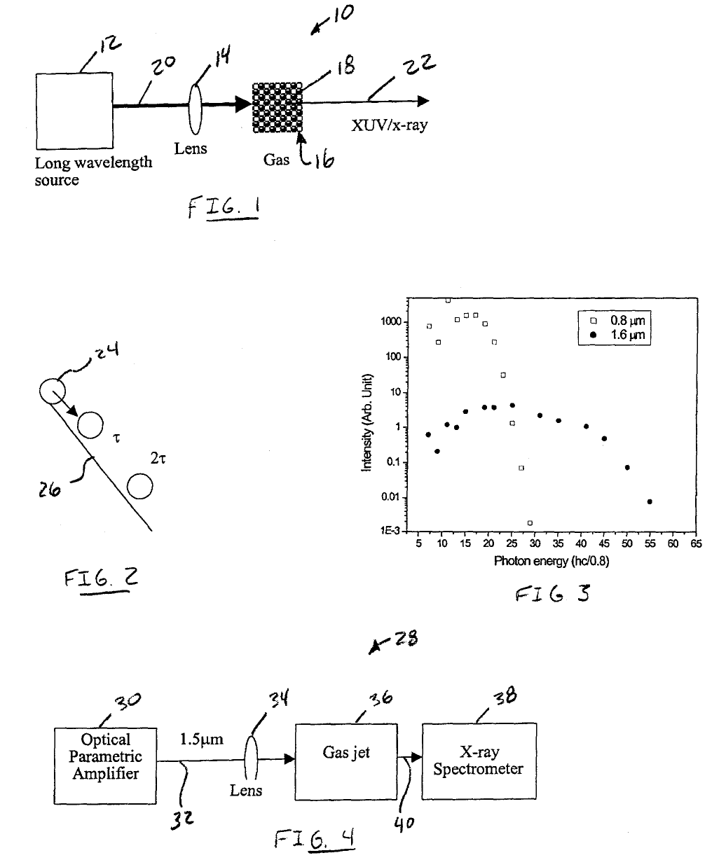

Referring to FIG. 2, a schematic analogy of electron acceleration in a light field is illustrated. The movement of an electron in a field of light is similar to a ball 24 falling along a slope 26. When the wavelength of the light is doubled, it is equivalent to doubling the time for the ball 24 to fall. This quadruples the kinetic energy of the ball 24. In the same way, the electron gains four times the energy in the field of light with wavelength λ/2 than in the field of light with wavelength λ. The more energy the electron receives, the higher the photon energy of the x-ray emitted when recombined with the parent ion.

Turning now to FIG. 3, a comparison of calculated spectra from xenon gas interacting with 0.8 μm and 1.6 μm light is illustrated. The simulation is based on the Lewenstein model, which is the quantum mechanics treatment of the above mentioned three-step model of high harmonic generation. The Lewenstein model is valid for the calculation of harmonics with photon energy much higher than the ionization potential, which is suitable for the present case.

As can be seen in FIG. 3, the results clearly show the advantage of producing x-rays with long wavelength light. The photon energy produced by the 1.6 μm light is twice as large as the photon energy produced by the 0.8 μm light.

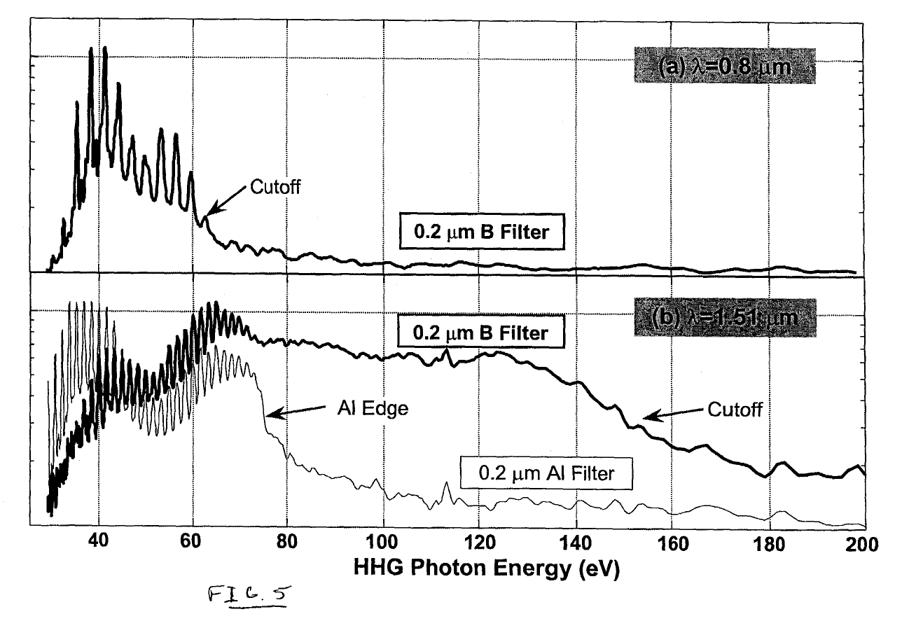

Referring now to FIG. 4, another apparatus for generating x-rays with long wavelength light is shown. The apparatus 28 includes an optical parametric amplifier 30 for producing a beam 32. The beam is focused by a lens 34 (or mirror) toward a gas stream produced by a gas jet 36. An x-ray spectrometer 38 is positioned to receive and analyze the resultant x-ray 40.

In an experimental run, an optical parametric amplifier 30 (OPA800, Spectraphysics) capable of generating both signal and idler beams was employed. The amplifier 30 was set so as to yield a signal beam 32 tunable from 1 to 1.6 μm. The pulse energy of the signal beam 32 from the amplifier 30 was 30 μJ. The signal beam 32 was focused toward the gas by a 100 mm lens 34. The focal spot size was ˜20 μm FWHM. The intensity of the beam 32 at the focus was ˜1×10¹⁴ W/cm².

The gas density from the pulsed gas jet 36 was ˜1×10¹⁷ atoms/cm³. The interaction length was ˜200 μm. A transmission grating spectrometer 38 was used to measure the resultant x-ray 40. The spectrometer 38 can measure x-rays from 15 to 1000 eV. The dispersed x-ray 40 was detected by an MCP image intensifier and a 16 bit CCD camera (neither shown).

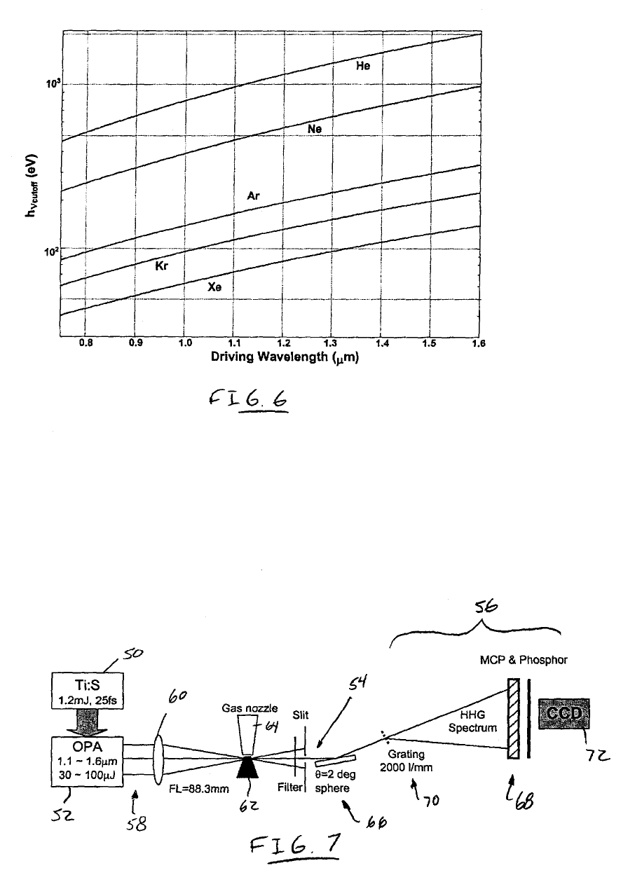

FIG. 5 shows experimental results with argon gas. The optical parametric amplifier pulse energy for this experiment was measured to be 100 μJ before the interaction chamber. In the measurement, 0.2 μm Al or B filters were used to suppress the noise by the high order grating diffraction of the low order harmonics. Results with an Al filter (thin line) and a B filter (thick line) are both illustrated in FIG. 5(b). As can be seen, the cut-off is at ˜160 eV with the B filter. The harmonic peaks above 70 eV are not resolved due to the resolution of the x-ray spectrometer 38. This portion of radiation can be blocked by the Al filter as shown in FIG. 5(b).

For comparison, the high harmonic generation by 0.8 μm laser was measured under the same conditions. The focal spot size is also kept at 20 μm and pulse energy ˜100 μJ. The result is shown in FIG. 5(a), in which the cut-off is located at ˜64 eV, much lower than that produced by the 1.51 μm laser. The spacing between adjacent harmonic peaks by the 1.51 μm driving field is about half of that by the 0.8 μm pump laser. This makes full tunability easier for the long wavelength driving field. By applying the same method as described above to helium gas, coherent x-rays above 1 keV should be producible.

Although the x-ray source of the present invention will find usefulness in a myriad of applications, it may be particularly well suited for x-ray lithography in semiconductor chip manufacturing, x-ray microscopy imaging in medical and biology studies, as well as potential use in material studies.

The following presents an experimental demonstration for extending the high order harmonic cut-off photon energy by more than a factor of two when the driving field wavelength is changed from 0.8 μm to 1.51 μm with an optical parametric amplifier. With argon gas, the cut-off has been extended from 64 eV to ˜160 eV. Coherent keV x-rays should be generated by exciting helium gas with such long wavelength driving pulses. Experiments on xenon gas with several pump wavelengths also showed the dramatic cut-off extension, as well as full tunability of the generated x-ray (xuv) wavelengths.

The following experimental conditions fall into the tunneling regime, in which the dependence of cut-off photon energy on a laser pulse parameter and an atomic parameter is described by equation 1:

$${hv}_{cutoff} = {I}_{p} + \frac{0.5 {I}_{p}^{3 + a} {λ}^{2}}{{[ ln \frac{0.86 Δ {t3}^{2 {n}^{*} - 1} {G}_{l m} {C}_{{n}^{*} {l}^{*}}^{2} {I}_{p}}{- ln ( 1 - p )} ]}^{2}} \qquad ( 1 )$$

Where Iₚ is the ionization potential, Δt and λ are the duration and the wavelength of the laser pulse respectively.

$${G}_{l m} = \frac{( 2 l + 1 ) ( l + \vert m \vert ) !}{{2}^{\vert m \vert} \vert m \vert ! ( l - \vert m \vert ) !} , and {C}_{{n}^{*} {l}^{*}}^{2} = \frac{{2}^{2 {n}^{*}}}{{n}^{*} Γ ( {n}^{*} + {l}^{*} + 1 ) Γ ( {n}^{*} - {l}^{*} )} .$$

I and m are the orbital and magnetic quantum number. n* is the effective principle quantum number, I*=I−n*. p=98% is the ionization probability at the peak of the pulse. a=0.5 is a correction of the analytical approximation. The results calculated with this formula agree well with the experimental results obtained by 0.8 μm laser interacting with various atomic species.

As described above, previous extension of the cut-off photon energy has been successfully achieved by interacting atoms with ultrashort driving pulses, as indicated by Eq. (1). Pulses as short as 5-7 fs have been employed and successfully generated 0.5 keV x-ray emission. However, since such pulses are already approaching one optical cycle, it is very hard to push the cut-off significantly by further reducing the laser pulse. According to Eq. (1), the cut-off photon energy strongly depends on the ionization potential. In fact, the record cut-off was achieved with helium which has the largest ionization potential among all atoms. Ions can give even larger ionization potential, which offers another possibility to significantly extend the cut-off as shown by several simulations.

Another significant parameter in Eq. (1) is the wavelength of the driving pulse. That is, the cut-off photon energy for a given atomic state is almost proportional to the square of the wavelength. FIG. 6 shows the calculation results of the relationship between single atom cut-off with the driving field wavelength. FIG. 6 shows that by changing the driving field wavelength from 0.8 μm to 1.6 μm, the cut-off of helium is extended from ˜0.5 keV to ˜2 keV.

The measured cut-off with the 0.8 and 1.51 μm pumps illustrated in FIG. 5 are both lower than the single atom calculation results in FIG. 6. This can be accounted for by the macroscopic effect of the harmonic generation process. It is well know that the measured harmonic signal is strongly affected by the phase matching. In the ionized medium, the phase match length is determined by the focusing, dispersion and intensity-dependent phase. The Rayleigh range of the focused pump beam is less than ten times the gas medium length. Therefore, the effect of Guoy phase shift and intensity-dependent phase should be significant. At the tested gas pressure and laser intensity, the dispersion and defocusing of plasma affect the harmonic yield. In general, these effects are stronger for higher orders, which limited the observed cutoff order.

In the tunneling ionization process, the ionization rate is independent of the laser wavelength. Therefore the saturation intensity is the same for pulses with the same duration but different wavelengths. As a result, electrons experience the same field strength at saturation intensities for pulses with different wavelengths. The kinetic energy of an electron acquired in a given potential field is proportional to the square of the travel time in the field. Therefore, the electrons can gain more energy in a longer optical period field, i.e., a longer wavelength field, to generate higher harmonics.

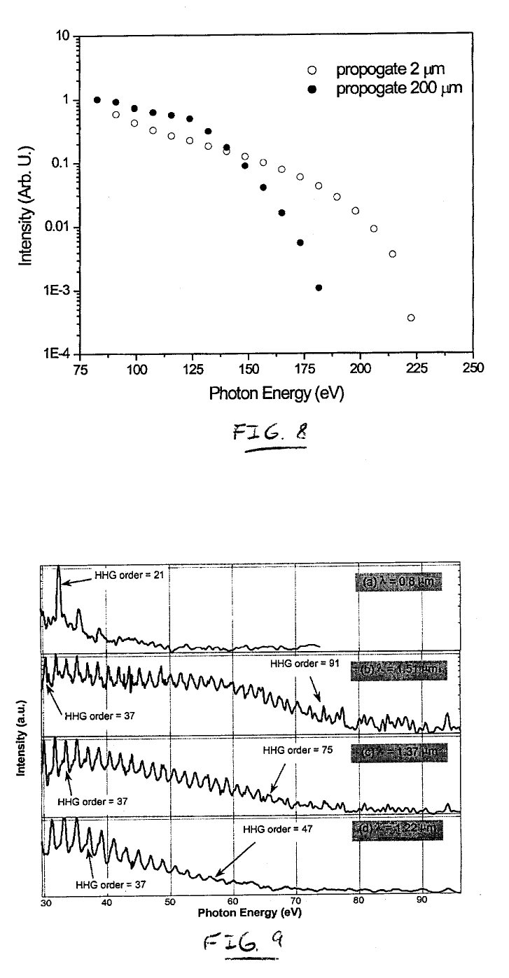

Turning to FIG. 7, a long wavelength driven experiment was performed with a tabletop Ti:Sapphire laser system 50 used with an optical parametric amplifier (OPA) 52. The generated high harmonic generation signal 54 is measured by a transmission grating based x-ray spectrometer 56. The OPA 52 pumped by 25 fs, 1.2 mJ sub-kHz laser pulses centered at 0.8 μm, generates tunable 1.1 to 1.6 μm IR laser pulses with pulse energy ranging from 30 to 100 μJ. The duration of the OPA 52 is also 25 fs as measured by an autocorrelator. The output 58 of OPA 52 is focused by an 88.3 mm lens 60 onto the pulsed gas jet 62 formed by a gas nozzle 64 synchronized with the laser signal. The focal spot size is ˜20 μm FWHM. The gas density from the pulsed jet is ˜1×10¹⁸ atoms/cm³ in a 200 μm interaction region. The harmonics from the gas are imaged by a focusing mirror 66 at grazing incidence onto a chevron MCP imaging detector 68, which has a good sensitivity to wavelengths below 140 nm. A 2000 l/mm transmission grating 70 is employed to disperse the spectrum. Finally, The x-ray spectrum on the phosphor screen is recorded by a 16 bit cooled CCD camera 72.

Referring to FIG. 8, to evaluate the macroscopic effects on the harmonic generation with long wavelength light, the harmonic spectra were simulated using parameters that mimic the experimental conditions. First, the single atom response is calculated using the method developed by Becker et al in Physical Review A, 41, 4112 (1990). The result is then put into the wave equation to calculate the harmonic signal from the gas. The simulation was done for argon gas with 2 μm and 200 μm medium lengths by the 1.51 μm pump. The result is shown in FIG. 8. As is shown, the cut-off reaches as high as 225 eV under the short medium length (2 μm) case, where the phase mismatch is not a big problem. When the medium length increases to 200 μm, the cut-off was ˜180 eV, which is lower than the 2 μm case. This implies that phase matching plays an important role under the above-described experimental conditions. This can be improved by loose focusing the pump beam and operating the system at low pressures or by using a hollow-core fiber technique.

Experiments have also been done with xenon gas. FIG. 9 shows the results with xenon gas at several wavelengths. FIG. 9(a) is the result produced by a fundamental 0.8 μm laser. FIGS. 9(b), 9(c) and 9(d) are the results produced by the output from an optical parametric amplifier tuned at 1.51 μm, 1.37 μm and 1.22 μm, respectively. FIG. 9 clearly illustrates the cut-off dependence on the driving field wavelength.

At a given harmonic order, the intensity of the harmonic signal decreases with an increase of pump wavelength. The intensities of the 37th high harmonic generation peaks in FIGS. 9(b), 9(c) and 9(d) were estimated. The relative intensity ratio of the spectral line for 1.22, 1.37 and 1.51 μm pumps are roughly 1:0.69:0.25. This can be accounted for by the effect of the quantum diffusion of the wave packet.

As described by the above semiclassic three-step model, the harmonics are generated by the recombination of the previously ionized electrons. The high harmonic generation intensity is proportional to the probability of the recombination, which is strongly affected by the overlap of the returning wave packet and the Coulomb potential well. A longer wavelength driving field causes a longer propagation time which leads to a bigger wave packet because of quantum diffusion.

The wave packet spreads with its propagation time τ as τ^{3/2}, and harmonic intensity decreases by the square of this factor. Calculations based on this relationship show that the intensity ratio is 1:0.71:0.53 for the same order high harmonic generation peaks produced by 1.22, 1.37 and 1.51 μm pumps. The first ratio 1:0.71 for 1.22 and 1.37 μm pumps is close to the measured value (1:0.69). However, the calculated relative intensity for 1.51 μm pump is almost twice the measured value.

The discrepancy between the measured and calculated results is likely caused by both the precision of the experiments and the calculation since the analytical calculation neglects the real Coulomb potential of atoms. Compared to the measurements of harmonic efficiency and nonsequential ionization with elliptically polarized light, the method demonstrated here provides a powerful way to study quantum diffusion of the wave packet in the strong field.

Another advantage of using an optical parametric amplifier is tunability, which consequently gives the tunability of the generated high harmonic generation emission. It is well know that conventional high harmonic generation produces only odd harmonics except when the pump pulses are close to single cycle. For spectroscopic applications, it is highly desirable to tune the harmonic peak positions to hit the resonance of the matter to be studied. In FIG. 9, the photon energy range covered by the 37^{th} harmonic of 1.22 μm and the same harmonic order of the 1.51 μm is much larger than the gap between two adjacent odd harmonic orders of either driving field. That means one can tune the harmonic to any position in the gap. In fact, full tunability can be realized at much lower harmonic orders.

Assume the optical parametric amplifier output can be tuned between λ₁ and λ₂. If the qth harmonic of λ₁ can be tuned to the adjacent harmonic of λ₂, i.e. λ₁/q=λ₂/(q+2), the high harmonic generation spectrum above λ₁/q will be fully tunable. Since the experimental optical parametric amplifier can be tuned between 1.1 to 1.6 μm, the above equation gives q=5. Therefore, the high harmonic generation source pumped by this optical parametric amplifier is completely tunable between 1.1/5=0.22 μm up to the cut-off. This is the first demonstration of full tunability in the soft x-ray range with an optical parametric amplifier. Compared to the previously proposed tuning scheme with wave mixing that requires precise temporal and spatial overlap of the strong fixed wavelength pulses and the tunable weak optical parametric amplifier pulses, the method demonstrated here is much simpler. It should also be noticed that the wave mixing experiments so far only show partial tuning, e.g. <70% of the gap between adjacent orders.

In conclusion, high harmonic generation is performed in the 1.2 to 1.5 μm pump wavelength range using an ultrafast high intensity optical parametric amplifier. This type of optical parametric amplifier can also be used to study other nonperturbative responses of matter to the long wavelength field. The results show that using a long wavelength pump is a very effective way to extend the cutoff of harmonic radiation. Ultrafast coherent keV x-rays should be able to be generated by further increasing the intensity of the optical parametric amplifier and interacting the light with atoms with larger ionization potential. Even longer wavelength driving fields will also lead to further extension of the harmonic cutoff, which can be done with the idler signal of the optical parametric amplifier.

It should be noted that a compromise must be made between harmonic intensity and wavelength range. The experiments show that the harmonic signal is weaker for a longer wavelength driving field which is consistent with the semiclassic three-step theory. The intensity difference of the same order harmonics produced by several wavelength pumps is attributed to the effect of quantum diffusion. The harmonic radiation generated by an optical parametric amplifier is fully tunable from VUV to x-ray. Just like optical parametric amplifiers are currently significant to spectroscopy studied in the UV to IR range, the tunable x-ray source will have a large impact on applications of ultrafast coherent x-ray.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus for generating an x-ray comprising:
a long wavelength light source producing long wavelength light; and
a gas positioned to receive said long wavelength light;
wherein an intensity of said long wavelength light is sufficient to ionize said gas and generate said x-ray.

2. The apparatus of claim 1 wherein said long wavelength light further comprises a wavelength between about 1.1 and about 1.6 μm.

3. The apparatus of claim 2 wherein said long wavelength light further comprises a wavelength between about 1.4 and about 1.6 μm.

4. The apparatus of claim 3 wherein said long wavelength light further comprises a wavelength of about 1.51 μm.

5. The apparatus of claim 1 further comprising an optical member disposed downstream of said long wavelength light source and focusing said long wavelength light to said gas.

6. The apparatus of claim 5 wherein said optical member focuses said long wavelength light to a focal spot size of about 20 μm.

7. The apparatus of claim 1 wherein said gas further comprises at least one of the group consisting of argon, xenon and helium.

8. The apparatus of claim 1 wherein said gas further comprises a gas stream produced by a gas jet.

9. The apparatus of claim 8 wherein a gas density from said gas jet is about 1×10¹⁷ to about 1×10¹⁸ atoms/cm³.

10. The apparatus of claim 1 wherein said long wavelength light source further comprises a tunable source.

11. The apparatus of claim 1 wherein said long wavelength light source further comprises an optical parametric amplifier.

12. The apparatus of claim 1 wherein said long wavelength light source further comprises a source with a pulse energy ranging from about 30 to about 100 μJ.

13. The apparatus of claim 1 wherein said intensity of said long wavelength light is about 1×10¹⁴ W/cm².

14. A method of producing an x-ray comprising:
supplying a long wavelength light; and
interacting said long wavelength light with a gas at an intensity sufficient to ionize said gas and generate said x-ray.

15. The apparatus of claim 14 wherein said step of supplying said long wavelength light further comprises supplying light with a wavelength between about 1.1 and about 1.6 μm.

16. The apparatus of claim 15 wherein said step of supplying said long wavelength light further comprises supplying light with a wavelength between about 1.4 and about 1.6 μm.

17. The apparatus of claim 16 wherein said step of supplying said long wavelength light further comprises supplying light with a wavelength of about 1.51 μm.

18. The apparatus of claim 14 further comprising focusing said long wavelength light to said gas with an optical member.

19. The apparatus of claim 18 wherein said step of focusing said long wavelength light further comprises focusing said long wavelength light to a focal spot size of about 20 μm.

20. The apparatus of claim 14 wherein said gas further comprises at least one of the group consisting of argon, xenon and helium.

21. The apparatus of claim 14 further comprising supplying said gas as a gas stream with a gas jet.

22. The apparatus of claim 21 wherein a gas density from said gas jet is about 1×10¹⁷ to about 1×10¹⁸ atoms/cm³.

23. The apparatus of claim 14 wherein said step of supplying said long wavelength light source further comprises supplying said long wavelength light with a tunable source.

24. The apparatus of claim 14 wherein said step of supplying said long wavelength light source further comprises supplying said long wavelength light with an optical parametric amplifier.

25. The apparatus of claim 14 wherein said step of supplying said long wavelength light further comprises supplying said long wavelength light with a source having a pulse energy ranging from about 30 to about 100 μJ.

26. The apparatus of claim 14 wherein said intensity of said long wavelength light is about 1×10¹⁴ W/cm².
